(19) United States
(12) Patent Application Publication
(10) Pub. No.: US 2007/0199943 A1
(43) Pub. Date: Aug. 30, 2007

(54) Pot & pan savers/organizers

(76) Inventors: Carol Waldman, Jersey City, NJ (US); David Waldman, Jersey City, NJ (US)

Correspondence Address: Allan Chen & Associates, 225 Broadway, Suite 700, New York, NY, 10007, US

(21) Appl. No.: 11/363,017

(22) Filed: Feb. 27, 2006

(51) Int. Cl. A47J 27/00

(52) U.S. Cl. 220/573.3

(57) ABSTRACT

The nature of the invention deals with stacking and storing cookware with polytetrafluoroethylene, sold under the trademark TEFLON. safely on top of each other, without damaging their non-stick coatings. The cookware protector comprises a separator which positioned between two stacked cookware. The separator is made of a flexible material to conform to the different sizes and shapes of the cookware preventing scratching the non-stick surface on the bottom pan. In addition to functioning as a cookware protector, the separator made be used to function as a potholder, and/or as a table mat to protect furniture from hot cookware. Additionally, another embodiment of the cookware protector is flame retardant/resistant properties for safe usage in the kitchen.

### BACKGROUND OF THE INVENTION

1. Field of the Invention

This invention relates generally to uses with all types of polytetrafluoroethylene, TEFLON cookware in relation to stacking and storing without damaging their non-stick coatings. The cookware protector comprises a separator which is positioned between two stacked cookware.

2. Prior Art

A frying pan protector comprises a concave dish positioned between two stacked frying pans. The dish is soft enough to prevent scratching the non-stick coating on the bottom pan. The protector includes a top surface shaped to conform to the underside of the top frying pan. Protruding spacers arranged on the bottom of the dish elevates the dish so that it engages the underside of the top frying pan. The spacers also reduces the surface area in contact with the bottom frying pan for further minimizing wear on the non-stick surface. For example, U.S. Pat. No. 5,988,385 to Stephens discloses a dish which is placed in between pans. Such a dish poses limitations to the types of cookware to be used in relation to the dish. The size and shape of the dish must have a direct correlation to the pan. Additionally, such a dish may pose a fire risk if the user neglects to remove the dish before placing the pan onto a heating surface. Furthermore if such a dish is heated, due to the materials prescribed in U.S. Pat. No. 5,988,385 for the construction of the dish, may lead to the decomposition of the polymer material ruining said cookware. Lastly, U.S. Pat. No. 5,988,385 is limited to pans whereas the current invention is universal which may be utilized with any type of cookware varying in size and shape.

In terms of broad inclusion, the scratch prevention pan liner of the invention, in one aspect, comprises a layer of synthetic resinous material having a thickness substantially equal to the depth of the pan within which it is nested, and configured to conform to the interior surface of the pan within which it is nested. Additionally, the liner is formed with a central recess that partially matches the exterior configuration and dimensions of a smaller fry pan adapted to be superposed within the liner and above the pan below. In another aspect of the invention, a “set” of such liners is provided, each having an exterior configuration that conforms to the fry pan within which it is supported, and each having a central recess within which the pan above is nested in coaxial superposed relationship to the pan below on which it is non-contiguously or indirectly supported. In a third aspect of the invention, means are provided on each component of a “set” of such fry pan liner components operative to retain the handles of the stacked fry pans oriented in a common vertical plane. For example, U.S. Pat. No. 5,048,688 to Hicks requires customization of liners to match the exact specifications of cookware to be used in conjunction. Additionally, U.S. Pat. No. 5,048,688 utilizes multiple parts which can lead to additional clutter of the kitchen areas when not in use. Further, the user would have to account for corresponding parts which must be used together for a particular size and shape of cookware.

### OBJECTS OF THE INVENTION

The object of the present invention is to provide a safeguard for stored cookware by protecting the non-stick coating on stacked cookware against scratching and excess wear. The present invention is a universal cookware protector able to be used with any type of cookware varying in size or shape.

An additional object of the present invention is that it may also be utilized as a pot holder to provide further convenience to the user without excessively cluttering the kitchen areas. Further, since the present invention would be in close proximity to cookware such a duel purpose would be ideal. The present invention not only has the ability to protect cookware but also the users of such cookware.

Still another object of the present invention is to function as a table mat protecting surfaces from hot cookware. Along with the advantages as stated above such invention can revolutionize kitchen accessories and facilitate a more pleasant cooking experience by the user.

### BRIEF SUMMARY OF THE INVENTION

The nature of the invention deals with stacking and storing cookware with polytetrafluoroethylene, sold under the trademark TEFLON. safely on top of each other, without damaging their non-stick coatings. The cookware protector comprises a separator which positioned between two stacked cookware. The separator is made of a flexible material to conform to the different sizes and shapes of the cookware preventing scratching the non-stick surface on the bottom pan. In addition to functioning as a cookware protector, the separator made be used to function as a potholder, and/or as a table mat to protect furniture from hot cookware. Additionally, another embodiment of the cookware protector is flame retardant/resistant properties for safe usage in the kitchen.

The present invention is a universal cookware protector able to be used with any type of cookware varying in size or shape.

### BRIEF DESCRIPTION OF THE DRAWINGS

FIG. 1 is a top view of a cookware protector in accordance with the invention fitted between two stacked pans.

FIG. 2 is a side sectional view of the cookware protector.

FIG. 3 is a top view of one embodiment of the cookware protector secured onto a pan.

FIG. 4 is a top view of an odd shaped pan which can be utilized with said invention.

FIG. 5 is the top view of the cookware protector with an aesthetic design.

FIG. 6 is the top view of the cookware protector shaped in accordance to the design.

FIG. 7 is the top view of the cookware protector acting as a table mat protecting said table from the hot surface of the pan.

FIG. 8 is the side view one embodiment of the cookware protector acting as potholder with a person's hand inserted.

### DETAILED DESCRIPTION OF THE INVENTION

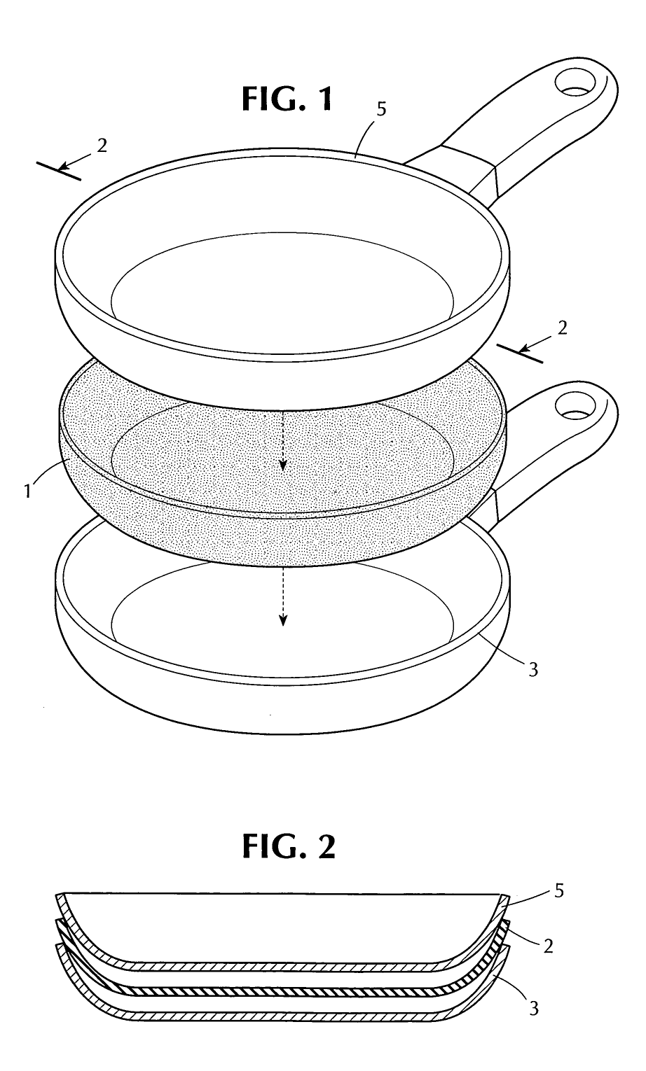

In accordance with a preferred embodiment of the invention shown in the top view of FIG. 1 a cookware protector 1 comprises a amorphous liner made of a sufficiently yielding material, such as but not limited to fabric, polymerized materials, sponge materials, foam materials, soft plastic or rubber. The cookware protector at rest in one embodiment may be flat, nevertheless, an additional embodiment be concaved in form. Once the cookware protector 1 is placed in between stacked cookware, said cookware protector 1 is able to take the form resembling the cookware. Cookware is commonly known in the art as any article used to store, cook, or heat food such as but not limited to pots, pans, glass cookware, ceramic cookware, or baking sheets

The side view as shown in FIG. 2 the cookware protector 1 is positioned between two stacked cookware, namely bottom positioned pan 3 and top positioned pan 5. The cookware protector separates and protects the delicate TEFLON cooking surface of the bottom positioned cookware 3 from the rigid underside of top positioned cookware 5.

Additionally as in FIG. 4, the present invention is universal capable of being used with different types, shapes, or sizes of cookware maybe stacked together such as but not limited to pots, casserole dishes, and pans. The present invention is not limited by the number of cookware stacked.

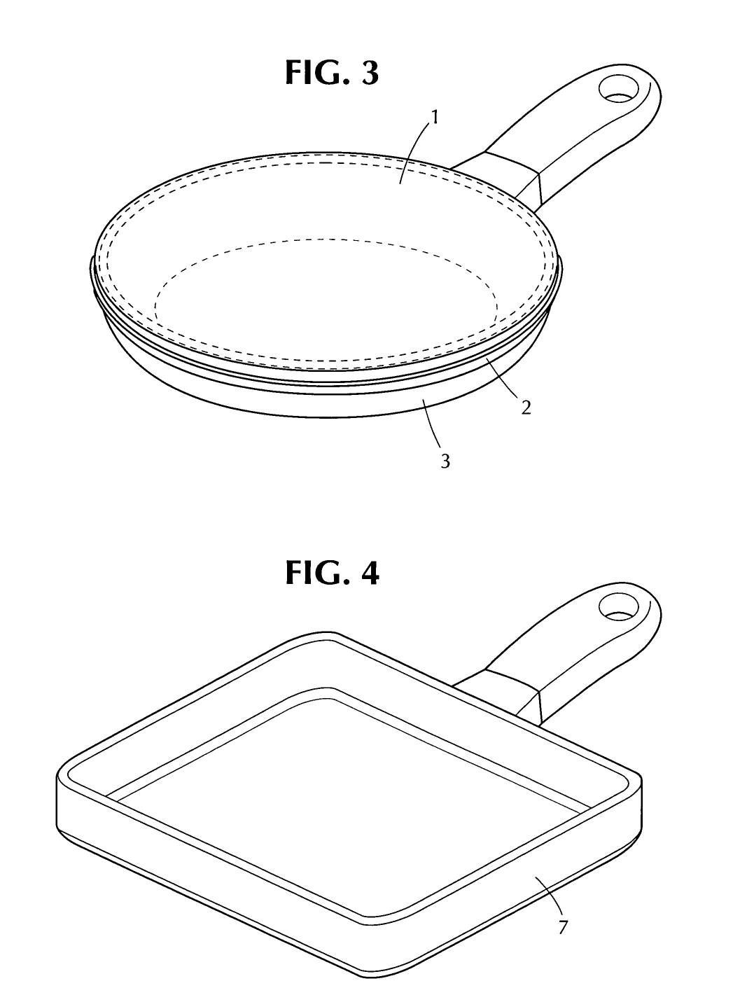

As shown in FIG. 3 an embodiment of the present invention, the cookware protector may be secured onto the bottom positioned pan 3 through means of elastic on the rim of the cookware protector 1. An alternative embodiment may contain magnet(s) embedded into to cookware protector to adhere to the cookware.

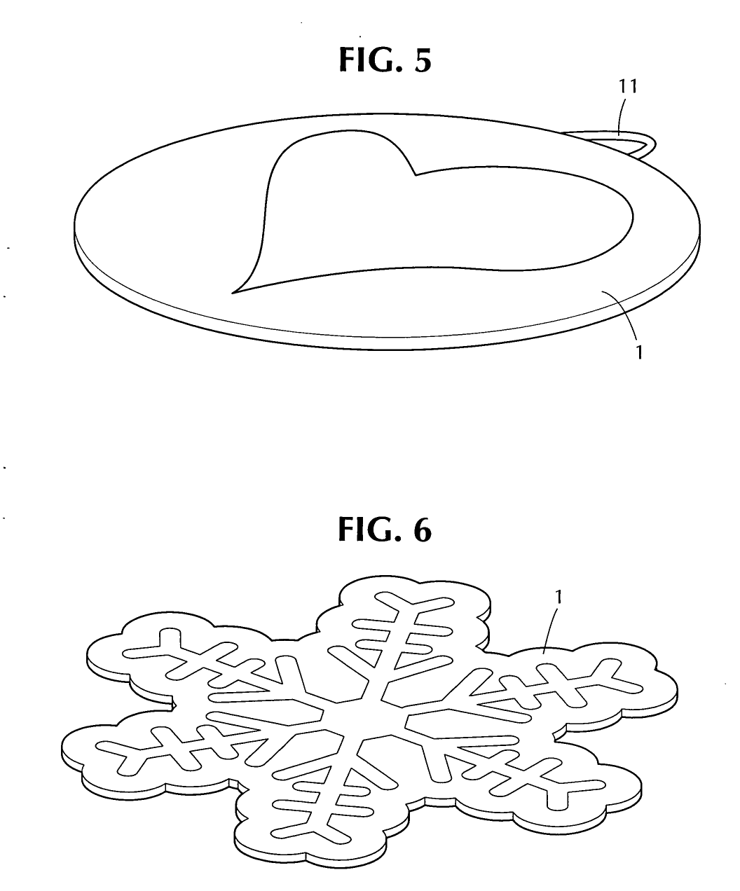

As shown in FIG. 5. and FIG. 6 the cookware protector 1 may be designed with an aesthetic appeal. A design may be place on the face of the cookware protector 1. Additionally, the cookware protector 1 maybe shaped in accordance to the design as shown in FIG. 6. One embodiment of the cookware protector may be shaped and look like a popular cartoon character. Additionally, the cookware protector may not be void of orifices. Another embodiment of the cookware protector 1 may take the shape of a spiral. Additionally, the cookware protector 1 may be in the shape of a heart and colored red. There is no limitation on the size, shape, or configuration of said cookware protector 1. Once stacked between cookware, the cookware protector will take the shape and form of the cookware stacked. Additionally, the cookware protector may have an ear 11 to facilitate storage by hanging said protector when not in use.

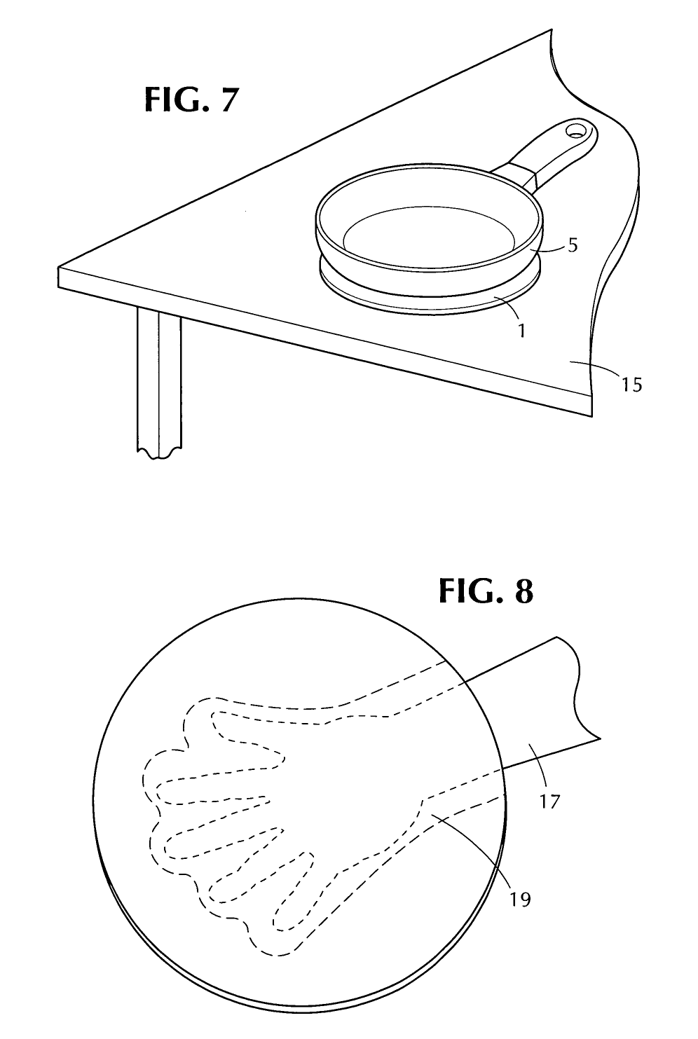

As shown in FIG. 7, the cookware protector 1 is used as a table mat to protect the furniture surface 15 from the hot piece of cookware 5.

As shown in FIG. 8, a user's hand 17 may be inserted into the cookware protector 1 to be used as a potholder or oven mitt to protect the user from said hot cookware. An alternative embodiment of the cookware protector being used as a potholder is to just fold the cookware protector insulating the users hand from the hot surface.

Additional features of the cookware protector 1 may be disposability. The cookware protector 1 can be composed primarily of paper fibers. Another embodiment of the cookware protector 1 may be either flame retardant or flame resistant. The cookware protector may be intertwined with materials such as but not limited to Nomex or Kevlar. Additionally, one embodiment of the present invention may be machine washable. The user could potentially clean the cookware protector in a washing machine, dish washer, or it may also be hand washed. In another embodiment of the invention, the cookware protector is non-stick. The cookware protector may either be coated with a substance such as TEFLON, or otherwise known in the art.

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below.

1. A cookware protector comprising:
a liner which is amorphous, and non-rigid intended to be inserted in between delicate surfaces of cookware in order to facilitate stacking of such cookware without damaging the surface integrity of said cookware.

2. A cookware protector as in claim 1, whereas said liner is comprised of a fabric material.

3. A cookware protector as in claim 1, whereas said liner is comprised of a polymer material.

4. A cookware protector as in claim 1, whereas said liner is comprised of a sponge like material.

5. A cookware protector as in claim 1, whereas the non stick surface is facilitated through a coating of the liner.

6. A cookware protector as in claim 1, whereas the liner is removably secured to said cookware through an elastic material on circumference of the liner's rim.

7. A cookware protector as in claim 1, whereas the liner is removably secured to said cookware through the means of embedded magnets within the liner.

8. A cookware protector as in claim 1, whereas the liner may be shaped and designed in an aesthetic fashion.

9. A cookware protector as in claim 1, whereas said liner may also be utilized as table mats to protect surface of furniture when placing cookware onto such furniture.

10. A cookware protector as in claim 1, whereas said cookware surface coated with Teflon.

11. A cookware protector as in claim 1, whereas said liner is disposable.

12. A cookware protector as in claim 1, whereas said liner is machine washable.

13. A cookware protector as in claim 1, whereas said liner is composed of Nomex.

14. A cookware protector as in claim 1, whereas said liner is composed of Kevlar.

15. A cookware protector as in claim 1, whereas said liner is flame retardant.

16. A cookware protector as in claim 1, whereas said liner is flame resistant.

17. A cookware protector as in claim 1, whereas said liner is functional as a potholder.

18. A cookware protector as in claim 1, whereas said liner may be hung from a hook.

19. A cookware protector comprising:
a liner which is amorphous, non-flammable, and non stick intended to be inserted in between delicate surfaces of cookware in order to facilitate stacking of such cookware without damaging the surface integrity of said cookware, and;
an elastic material on circumference of the liner's rim to removably secure the liner in place.

20. A cookware protector as in claim 1, whereas said liner is semi-rigid

21. A cookware protector comprising:
a liner which is non-flammable, and non-rigid, intended to be inserted in between delicate surfaces of cookware in order to facilitate stacking of such cookware without damaging the surface integrity of said cookware, and;
said liner shaped and designed in an aesthetic fashion.
